(19) United States
(12) Patent Application Publication
(10) Pub. No.: US 2010/0246484 A1
(43) Pub. Date: Sep. 30, 2010

(54) COMMUNICATION MANAGEMENT APPARATUS AND LOCATION MANAGEMENT APPARATUS

(75) Inventors: Jun Hirano, Kanagawa (JP); Keigo Aso, Kanagawa (JP); Tien Ming Benjamin Koh, Singapore (SG); Chun Keong Benjamin Lim, Singapore (SG); Chan Wah Ng, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/438,467

(22) PCT Filed: Aug. 24, 2007
(86) PCT No.: PCT/JP2007/066961

§ 371 Date: Feb. 23, 2009

(30) Foreign Application Priority Data
Aug. 24, 2006 (JP) 2006-228004
Jul. 20, 2007 (JP) 2007-189703

(51) Int. Cl. H04W 8/00

(52) U.S. Cl. 370/328

(57) ABSTRACT

The present invention provides a new technique, according to which a mobile router can fulfill functions as a dynamic home agent, in a system where a plurality of mobile routers are in operation, under the management of a service provider belonging to the home agent. According to this technique, the home agent verifies the legitimacy of the mobile router when it receives a Query message and a binding update message requesting permission to fulfill functions as dynamic home agent. Then, after confirming that no other mobile router is currently present, which is fulfilling the functions as dynamic home agent in a set of a plurality of mobile routers, to which this mobile router belongs, it allows said mobile router to operate as the dynamic home agent. Then, even when other mobile router requests the permission to fulfill functions as the dynamic home agent, the request is rejected, and said other mobile router utilizes the mobile router, which is fulfilling functions of the dynamic home agent, as its home agent.

### TECHNICAL FIELD

The present invention relates to a communication management apparatus and a location management apparatus for communication in a packet switched data communication network. In particular, the invention relates to a communication management apparatus and a location management apparatus, which provide means for achieving authenticated, authorized and accounted network services and sharing of resources in mobile networks by a plurality of mobile routers and in dynamic environment and manner.

### BACKGROUND ART

In recent years, users have increased, who typically carry a plurality of devices to perform wireless communication with each other. For instance, as an example of such devices, laptop computer, PDA (Personal Digital Assistant), cellular phone, etc. are known. Among these devices, there is a device, which may be configured to provide access to the global network by using available access network interface. For example, in case a user is present within hot-spot communication range of WiFi (Wireless Fidelity), the PDA may use WiFi interface of a laptop computer. In case the user moves away from hot-spot, PDA can switch over so that it can use the connectivity of cellular phone. In fact, the user is actually carrying a mobile network in form of PAN (Personal Area Network). Also, in the foreseeable future, it is anticipated that more and more entertainment devices such as portable music and video players or other entertainment consoles would require the connectivity to global communication network.

There are such possibilities in future that PAN will be more propagated and PAN may be shared by every member of a family. On the other hand, a technique of NEMO (Network Mobility) is offered by IETF (Internet Engineering Task Force) (see the Non-Patent Document 1 given below). NEMO makes it possible to implement the mobility management for the entire network by changing the point of attachment to Internet with the entire network as one unit. It is also possible to actualize the reachability in topology. In the mobile network, one or more mobile routers (MRs) to relay the connectivity to global Internet are included.

The mobile network is assumed to be a leaf network, and it does not carry transit traffic. However, by using a single MR with a plurality of points of attachment in Internet or by using a plurality of MRs, which can connect the mobile network to Internet, the mobile network can be turned to multi-home state.

NEMO is such a technique that nodes under the control of MR (nodes behind MR) may not become aware of network mobility (moving of network), and the moving of network should be in fully transparent state to the nodes within the mobile network. In NEMO, therefore, a node, generally not being aware of mobility, is accommodated in the network.

In the basic approach of the network mobility support, each mobile router (MR) has a home agent (HA). By using a bi-directional tunnel between MR and HA, continuity of sessions is maintained even when MR is in the course of moving. Similarly to the mobile node (mobile host), which uses mobile IP, MR acquires the care-of address (CoA) from the point of attachment. In this approach, each MR is regarded merely as a single node, and the mobile network can be in the state of nesting.

As described above, by using the technique of NEMO, the user can manage and control the mobile network and can reliably provide the reachability of the network to the device in PAN of the user. However, to attain full functions of NEMO, the user must utilize the service of HA or should use home address (HoA) or mobile network prefix relating to the mobile network with global reachability. This can be accomplished by borrowing the services of resources from the provider.

On the other hand, the user may not want to apply for individual account in relation to these services and resources in some cases for each of the family members, for instance due to infrequent usage or other reasons. Accordingly, it leads to the benefit of the service provider to offer a plan, which dynamically allows more than one PANS to share the resources in authenticated, authorized and accounted manner. It is desirable that the cost of such services is higher than the cost of the case where it is applied only to a single PAN, and that it is lower than the case where two or more accounts are acquired. The reason for this is that several network resources can be commonly shared by a number of PANs.

At present, there is no definite principle in the offering of the services as described above. On the other hand, if some current solutions can be adapted, it may be possible to offer the same types of functions.

For example, according to the Patent Document 1 as given below, a method is proposed, which uses a learning prediction model to predict the presence of the user or the ratio of utilization. According to the technique described in the Patent Document 1, the content of user's calendar is analyzed, and data are collected by giving due consideration on the behavior of the user and on a distance from a number of devices.

According to the technique described in the Patent Document 2 as given below, network configuration information is utilized, which is stored in the device introduced or inserted in a client PC or gateway. The procedures for authentication and conflict resolution are included in this network configuration information.

According to the technique described in the Patent Document 3 as given below, a home agent which shares a part of resources is uniquely identified among the other home agents by using secondary link layer identifiers such as a pool of available home addresses.
[Patent Document 1] European Patent Publication No. 1505529
[Patent Document 2] U.S. Patent Publication No. 2005-0193103
[Patent Document 3] International Patent Publication WO2006/020740
[Non-Patent Document 1] Devarapalli, V., et al., “NEMO Basic Support Protocol”; Internet Engineering Task Force; Request For Comments 3963, January 2005.

However, the technique disclosed in the Patent Document 1 as given above has a problem in that the effectiveness may be lost if the behavior relating to user's mobility is inconsistent or unpredicted. For instance, during the period when the behavior or the location of the user cannot be predicted, the user may not be able to receive the services or the service provider may not be able to enforce the accounting procedure.

The technique disclosed in the Patent Document 2 may be adequate when AAA (Authentication, Authorization and Accounting) is carried out, but it does not offer a method, by which the user can dynamically share the network resources among a plurality of mobile networks.

The technique disclosed in the Patent Document 3 may allow a specific sharing node (each of nodes sharing some resources), but it does not offer a method, by which the user can dynamically share the network resources among a plurality of mobile devices.

As described above, in the prior art, no method is known, by which home address, mobile network prefix and communication configuration are dynamically managed so that adequate communication operation can be achieved in a plurality of mobile nodes (i.e. a plurality of mobile routers that have respective mobile networks, or a plurality of mobile hosts). Further, it is desirable that a method is implemented, by which the management of AAA can be executed on the side of service provider so that not only it can be operated on the user side but also illegitimate operation may not be performed on user side.

### DISCLOSURE OF THE INVENTION

To overcome the above problems in the prior art, it is an object of the present invention to provide a communication management apparatus and a location management apparatus, by which it is possible to adequately offer network services managed and controlled by service provider and to contribute to the accomplishment of resource sharing among a plurality of mobile nodes.

To attain the above object, the present invention provides a communication management apparatus being placed in a mobile node, the communication management apparatus being feasible to manage communication performed by other communication nodes, wherein the communication management apparatus comprises;

Query message sending means for sending a Query message including information to indicate that the mobile node is already registered and a binding update message for registration of location to a location management apparatus in charge of location management of said mobile node; and

communication management means for functioning as a primary node which manages the communication of a plurality of predetermined mobile nodes when said mobile node is confirmed as a registered device by said location management apparatus, said binding update message is accepted, a home address is allocated from the location management apparatus and said mobile node is permitted given to serve as the primary node which manages communication of the mobile node.

With the arrangement as described above, it is possible, in a system where a plurality of mobile nodes are in operation, that a mobile router can fulfill the functions as a dynamic home agent under the management of service provider, or a mobile node can fulfill the functions as a communication path setting node.

Also, the present invention provides the communication management apparatus with the arrangement as described above, wherein the mobile node where the communication management apparatus resides is a mobile router, and said mobile node functions as a dynamic home agent to a plurality of predetermined mobile nodes when the mobile network prefix is allocated with the home address from the location management apparatus and said mobile node serve as the primary node.

With the arrangement as described above, it is possible, in a system where a plurality of mobile nodes are in operation, that a mobile router can fulfill the functions as a dynamic home agent under the management of service provider.

Also, the present invention provides the communication management apparatus with the arrangement as described above, wherein said Query message requests a permission to fulfill functions as the dynamic home agent.

With the arrangement as described above, it is possible to explicitly request the permission to allow a home agent to fulfill functions as a dynamic home agent.

Further, the present invention provides the mobile network management apparatus with the arrangement as described above, wherein said communication management apparatus comprises registration message sending means for sending a registration request message for requesting a home address and a mobile network prefix and a binding update message for location registration to a mobile node currently fulfilling functions as a dynamic home agent among the plurality of predetermined mobile nodes in case said binding update message has not been accepted.

With the arrangement as described above, when there is already a mobile router, which is fulfilling the functions as a dynamic home agent, it is possible to perform communication by using the mobile router, which is fulfilling the functions of the dynamic home agent, as the home agent.

Also, the present invention provides the communication management apparatus with the arrangement as described above, wherein said communication management apparatus comprises negotiating means to have negotiation relating to said home address and said mobile network prefix to and from the mobile router currently fulfilling functions as a dynamic home agent in case said binding update message is accepted and the home address and the mobile network prefix are allocated from the mobile router currently fulfilling functions as said dynamic home agent or in case said binding update message is not accepted.

With the arrangement as described above, the mobile router, which is fulfilling the functions as a dynamic home agent, can negotiate with a mobile router, which has acquired home address and mobile network prefix but is not satisfying the conditions as desired, or with a mobile router, which could not acquire home address and mobile network prefix.

Further, the present invention provides the communication management apparatus with the arrangement as described above, wherein said communication management apparatus comprises:

disruption predicting means for predicting disruption of connectivity at said mobile router in advance; and

dynamic home agent function shifting means for proceeding to shift the functions of said dynamic home agent to a mobile router among plurality of predetermined mobile nodes in case the disruption of said connectivity is predicted by said disruption predicting means.

With the arrangement as described above, it is possible to shift the functions of the dynamic home agent seamlessly prior to the disruption of connectivity by predicting the disruption in advance.

Also, the present invention provides the communication management apparatus with the arrangement as described above, wherein said communication management apparatus comprises:

disruption detecting and confirming means for detecting and confirming disruption of connectivity at the mobile router currently fulfilling functions as said dynamic home agent; and

re-Query message sending means for sending a Query message added with a flag to urge re-confirmation of binding information and a binding update message for location registration, and for requesting permission to fulfill functions as the dynamic home agent including information to indicate that it is a registered device to a home agent for performing location management of said mobile router in case disruption of connectivity at the mobile router currently fulfilling functions as said dynamic home agent has been confirmed.

With the arrangement as described above, even when the connectivity of the mobile router, which is fulfilling the functions of a dynamic home agent, is disrupted, another mobile router can detect the disruption of the connectivity and can quickly inherit the functions of the dynamic home agent.

Also, the present invention provides the communication management apparatus with the arrangement as described above, wherein the mobile node in which the communication management apparatus resides is a mobile host, and said mobile node functions as a communication path setting node which sets a communication path of each of a plurality of predetermined mobile nodes when the mobile node serves as the primary node.

With the arrangement as described above, in a system where a plurality of mobile nodes are in operation, a home agent under the management of service provider can permit that a certain mobile node serves as a communication path setting node by confirming that this certain mobile node is a valid.

Also, the present invention provides the communication management apparatus with the arrangement as described above, wherein said Query message is to request permission to fulfill functions as said communication path setting node.

With the arrangement as described above, a mobile node can explicitly request permission to fulfill functions as a communication path setting node to the home agent.

Also, the present invention provides the communication management apparatus with the arrangement as described above, wherein the communication management apparatus comprises:

register message sending means for sending a message including necessary information to set a communication path for the mobile node and a binding update message for registering location to a mobile node functioning as a communication path setting node among the plurality of the predetermined mobile nodes in case said binding update message has not been accepted.

With the arrangement as described above, when there is already a mobile node, which is fulfilling the functions as a communication path setting node, it is possible to make the mobile router, which is fulfilling the functions of the communication path setting node, to configure the communication settings.

Also, the present invention provides the communication management apparatus with the arrangement as described above, wherein the communication management apparatus comprises:

disruption predicting means for predicting disruption at the mobile node in advance; and

communication path setting node function shifting means for proceeding to shift the functions of said communication path setting node to a mobile node among the plurality of predetermined mobile nodes in case that the disruption of said connectivity is predicted by said disruption predicting means.

With the arrangement as described above, it is possible to shift the functions of the dynamic home agent seamlessly prior to the disruption of connectivity by predicting the disruption in advance.

Also, the present invention provides the communication management apparatus with the arrangement as described above, wherein the communication management apparatus comprises:

disruption detecting and confirming means for detecting and confirming that disruption of connectivity at a mobile node currently fulfilling functions as the communication path setting node; and

re-Query message sending means for sending a Query message added with a flag to urge re-confirmation of binding information and a binding update message for location registration, and for requesting permission to fulfill functions as the communication path setting node including information to indicate that it is a registered device to the location management apparatus for performing location management of a mobile node currently fulfilling functions as said communication path setting node in case disruption of connectivity at the mobile node currently fulfilling functions as said communication path setting node has been confirmed.

With the arrangement as described above, even when the connectivity of the mobile node, which is fulfilling the functions of a dynamic home agent, is disrupted, another mobile node can detect the disruption of the connectivity and can quickly inherit the functions of the communication path setting node.

Further, to attain the above object, the present invention provides a location management apparatus for managing location of a mobile node wherein said location management apparatus comprises:

registration list maintaining means for maintaining a registration list by making a set of a plurality of mobile nodes;

binding cache for storing binding information to execute location management of said plurality of mobile nodes;

message receiving means for receiving a Query message including information to indicate that it is a registered device in said registration list and a binding update message for location registration from the mobile node;

verifying means for verifying legitimacy of said mobile node according to said registration list; and

primary node function permitting means for giving permission to function as a primary node which manages communication of other mobile nodes to a mobile node which is a source of said Query message when legitimacy of said mobile node has been confirmed by said verifying means.

With the arrangement as described above, in a system where a plurality of mobile nodes are in operation, a location management apparatus such as a home agent under the management of service provider can permit that a certain mobile node serves as a primary such as a dynamic home agent or a communication path setting node by confirming that this certain mobile node is a valid communication node.

Also, the present invention provides the location management apparatus, wherein a source of said Query message is a mobile router, and said Query message is to request permission to fulfill functions as said dynamic home agent for another mobile node.

With the arrangement as described above, in a system where a plurality of mobile nodes are in operation, a home agent under the management of service provider can permit that a certain mobile node serves as a dynamic home agent by confirming that this certain mobile node is a valid communication node.

Also, the present invention provides the location management apparatus, wherein said location management apparatus comprises:

dynamic home agent confirming means for judging whether it is adequate or not that said mobile node successfully verifying said legitimacy fulfills functions as a dynamic home agent by referring to said registration list and said binding information; and

said address/prefix allocating means for allocating a home address and a mobile network prefix to the mobile node which is the source of said Query message, and storing the allocated home address and mobile network prefix along with current location information of the mobile node as the binding information in case the legitimacy of said mobile router has been confirmed by said verifying means and in case said dynamic home agent confirming means judges it as adequate.

With the arrangement as described above, in a system where a plurality of mobile nodes are in operation, a home agent under the management of service provider can permit that a certain mobile node serves as a dynamic home agent by confirming that this certain mobile node is a valid communication node.

Also, the present invention provides the location management apparatus, wherein a source of said Query message is a mobile node, and said Query message is to request permission to fulfill functions as a communication path setting node which sets a communication path of another mobile node.

With the arrangement as described above, a mobile node can explicitly request permission to fulfill functions as a communication path setting node to the home agent.

Further, the present invention provides the location management apparatus, wherein said location management apparatus comprises:

communication path setting node confirming means for judging whether it is adequate or not that said mobile node successfully verifying said legitimacy fulfills functions as a communication path setting node by referring to said registration list and said binding information; and

said primary node function permitting means for giving permission to function as a primary node which manages another mobile node to the mobile node which is the source of said Query message in case the legitimacy of said mobile node has been confirmed by said verifying means and in case said communication path setting node confirming means judges it as adequate.

With the arrangement as described above, in a system where a plurality of mobile nodes are in operation, a home agent under the management of service provider can permit that a certain mobile node serves as a communication path setting node by confirming that this certain mobile node is a valid.

The present invention has the effects to adequately provide network services under management of service provider and the effects to achieve the sharing of resources among a plurality of mobile nodes in a system where a plurality of mobile nodes are in operation.

### BRIEF DESCRIPTION OF THE DRAWINGS

FIG. 1 is a drawing to show an example of network arrangement in an embodiment of the present invention;

FIG. 2 is a drawing to schematically show an example of a Query message to be sent from a mobile router in the embodiment of the present invention;

FIG. 3 is a drawing to schematically show an example of a registration request message to be sent from a mobile router in the embodiment of the present invention;

FIG. 4 is a flow chart to show an example of behavior of a home agent in the embodiment of the present invention;

FIG. 5 is a flow chart to show an example of behavior of a mobile router in the embodiment of the present invention;

FIG. 6 is a block diagram to show an example of arrangement of a home agent in the embodiment of the present invention;

FIG. 7 is a block diagram to show an example of arrangement of a mobile router in the embodiment of the present invention;

FIG. 8 is a drawing to show an example of network arrangement in another embodiment of the present invention; and

FIG. 9 is a flow chart to show an example of behavior of a mobile node in another embodiment of the present invention.

### BEST MODE FOR CARRYING OUT THE INVENTION

Description will be given below on an embodiment of the present invention referring to the attached drawings.

As it is defined in the specification of NEMO (see the Non-Patent Document 1), a mobile network can maintain global reachability without modifications to a correspondent node through the aid of a mobile router and a home agent. Specifically, a mobile router registers home address and mobile network prefix at a home agent. Further, information of current location (i.e. care-of address) is updated at the home agent. The home agent proceeds to act as a proxy on the home address and the mobile network prefix. The home agent must forward a normal packet when the packet is received. In so doing, a correspondent node can reach any node in the mobile network, which is configured with an address using the mobile network prefix. However, problem may arise when it is tried to use the same mobile network prefix in more than one mobile routers or mobile networks.

According to the prior art, under the condition that the first mobile router is used and information relating to the first mobile router is registered at the home agent, in case the second mobile router tries to register the same mobile network prefix, which is used by the first mobile router to a home agent, and if this mobile network prefix is already registered to a different address, the home agent rejects the binding. Also, in this case, if the home address is the same, the home agent accepts the binding and deletes the previous binding entry. According to the actions in these two cases, only one mobile router is entitled to be the designated target of the data packet addressed to the above mobile network prefix.

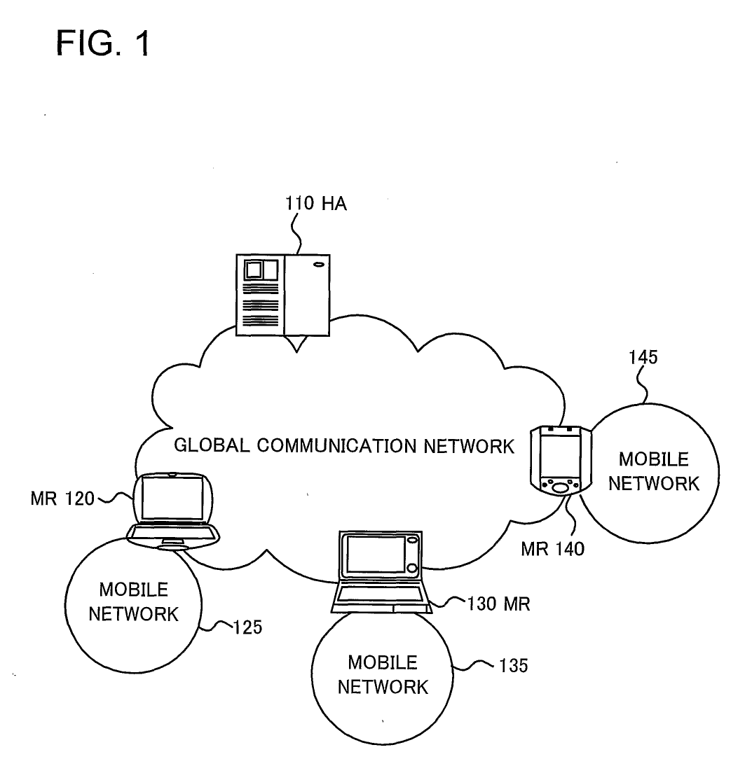

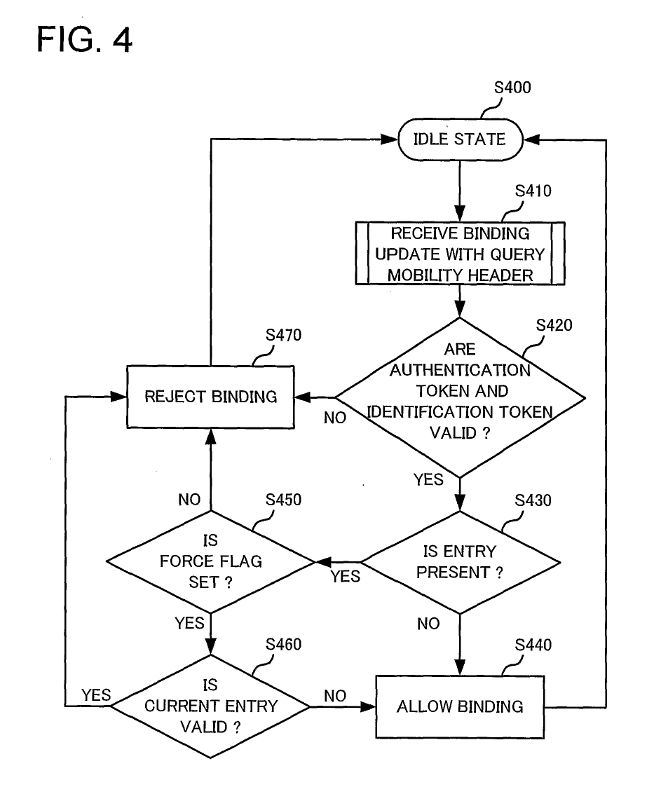

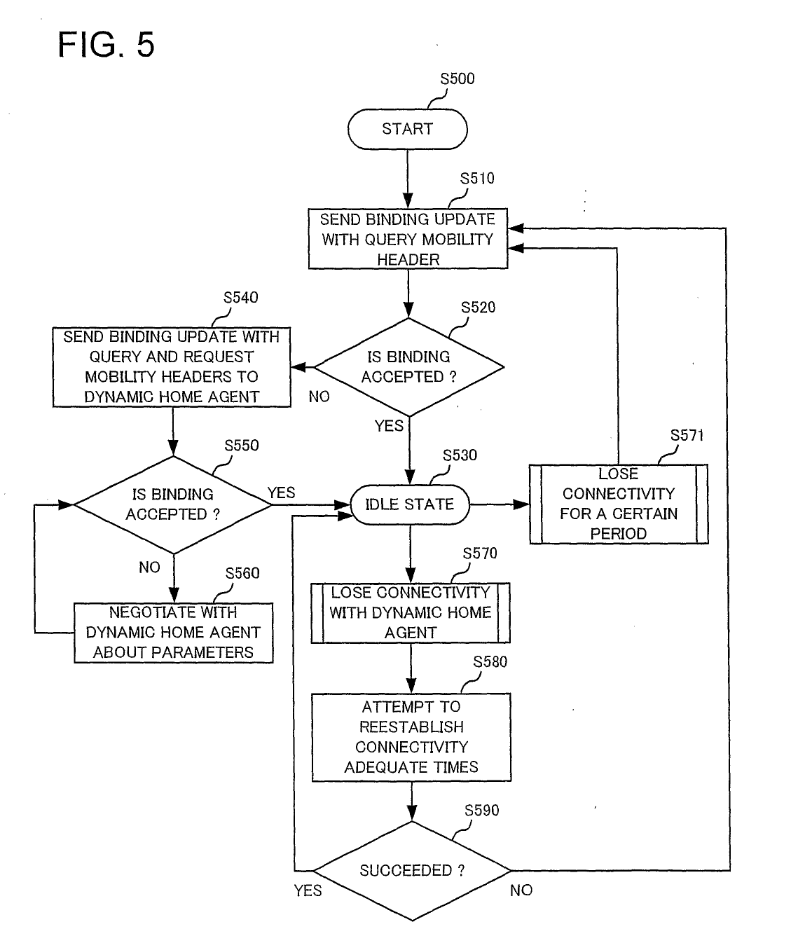

FIG. 1 shows a typical example of a scenario, in which mobile routers (MRs) 120, 130 and 140, each having a mobile network, are roaming in a global communication network 100. The mobile routers 120, 130 and 140 are served by a common home agent 110, which belongs to a service provider. In this scenario, it is assumed that the home address and the mobile network prefix received by the user from a service provider are commonly shared by three mobile routers 120, 130 and 140. Also, in relation to the scenario shown in FIG. 1, an example of the behavior of the home agent 110 in the embodiment of the present invention is shown in a flow chart of FIG. 4, and general outlines of the behaviors of the mobile routers 120, 130 and 140 in the present embodiment are shown in the flow chart of FIG. 5.

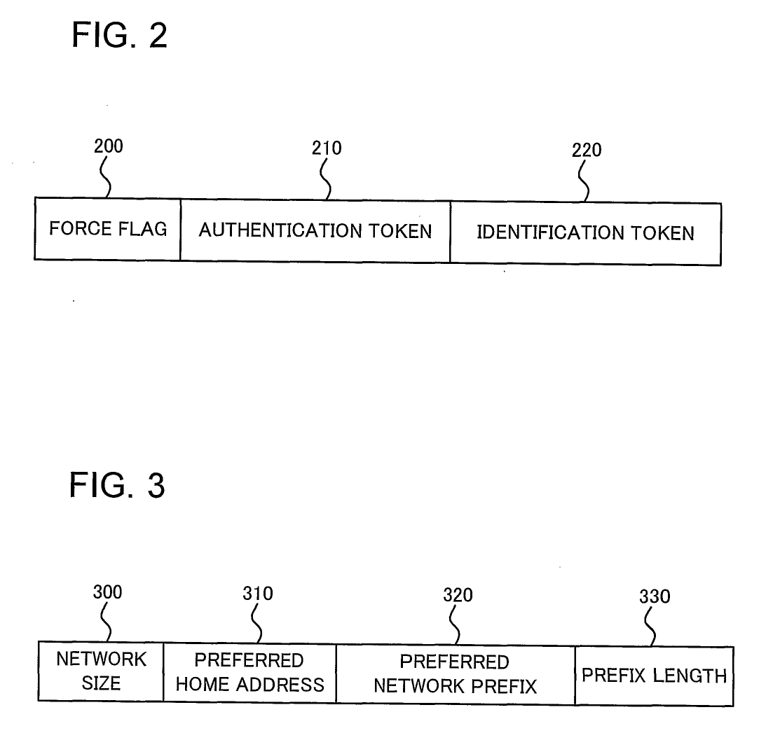

When the first mobile router starts up (Step S500), the first mobile router (hereinafter, it is referred as a mobile router 120) proceeds to send a Query message to the home agent 110 of the service provider. This Query message is such that a sender (mobile router 120) requests for allowance to serve as a primary node of another mobile router 130 or 140. As shown in FIG. 2, the Query message contains a Force flag 200, an authentication token 210, and an identification token 220 as shown in FIG. 2. The Force flag 220 is used to instruct to the home agent 110 that current availability of the existing entry should be checked. In case the result of the checking is “failure”, such as the case where the existing entry is not currently used, this would cause an override of the previous registration or binding entry.

Also, the authentication token 210 contains the information, by which it can be identified that the mobile router is a legitimate subscriber node, and the identification token 220 contains the information, by which the mobile router 120 can be uniquely identified. The uniqueness in this case is defined only for the purpose that the mobile routers 120, 130 and 140 can be differentiated from other mobile routers, to which the network provider is providing services. Therefore, this uniqueness may be either local or global in scope. Further, it may be so arranged that the identification token 220 is associated with the authentication token 210 so that the scope of uniqueness is limited to each user. In this case, the authentication token 210 and the identification token 220 would actually be a single parameter.

Also, it is desirable that PKI (Public Key Infrastructure) or other forms of authentication technique may preferably be used. Also, under a specific condition of implementation, it may be so designed that these three information elements are added to the current mobile IP protocol in form of a new Query mobility header type. In this case, the mobile router 120 would send a new Query mobility header together with normal binding update mobility header to the home agent 110 in Step S510 in FIG. 5, for instance. Here, as described above, assumption is made on a case where the mobile router 120 sends a Query message in form of a binding update having Query mobility header.

Further, in another preferred embodiment, it may be so designed that the authentication token 210 and the identification token 220 may be directly incorporated as options into any of the existing mobility headers such as the binding update mobility header.

Also, in still another preferred embodiment, the authentication token 210 and the identification token 220 may be transported via a mechanism of different layer (upper layer or lower layer) such as an application payload. When such method is used, it would be necessary to reinforce the function of optional application programming interface (API) in order that authentication processing can be incorporated in the operation of mobile IP. For instance, the mobile IP may make inquiry on permission or prohibition of a specific binding based on information such as the home address of the applicant to an entity of upper layer. Also, as an example of a mechanism of lower layer, the information stored in the Subscriber Identify Module (SIM) card of the user may be used.

On the other hand, when the home agent 110 receives a Query message (Step S410) under idle condition of Step S400, it is verified whether or not the transmitting node (sender) is a legitimate subscriber relating to the home address and the mobile network prefix described in the same message according to the authentication token 210 (Step S420). Here, assumption is made on a case where the Query message is sent in form of binding update of the Query mobility header.

In case the verification in Step S420 has failed, the home agent 110 sets up a reason code to indicate that the node is not a legitimate subscriber and sends back a binding error message and rejects the binding (Step S470). On the other hand, in case it is successfully verified, the home agent 110 proceeds to check whether the binding entry relating to this home address already exists or not (Step S430).

If an entry relating to this home address has not been found, the home agent 110 proceeds to create a new binding cache entry with a new identification field and accepts the binding (Step S440). The identification token 220 is used to uniquely identify the mobile router 120, which is a source of the binding entry. As a result, the mobile router 120 is now turned to a dynamic home agent relating to the block of address of the mobile network prefix acquired from the service provider.

From the subset of the mobile network prefix assigned as acquired from the home agent 110, the mobile router 120 should configure a different home address and a different mobile network prefix for its own use. For instance, the home address acquired from the service provider is “3000::1:A:B:C”, and the mobile network prefix is “3000:0:0:0:1::/80”. In case it is assumed that the mobile router 120 supports the mobile network of network size “65000”, the mobile router 120 would configure “3000:1:0:1:1” as its own home address and would use the mobile network prefix of “3000:0:0:0:1:0:::/112” for own mobile network. It is desirable that the mobile router 120 uses a self-configured home address for all of its data-plane communications. This is advantageous in that the functions of the dynamic home agent can be easily shifted to the other mobile router without disrupting the data-plane communication when necessary.

Also, in FIG. 5, when the mobile router 130 starts up (Step S500), a binding update having the Query mobility header is sent to the home agent 110 (Step S510).

In this case, if the home agent 110 follows after the processing shown in FIG. 4, a binding entry already registered in a different mobile router (mobile router 120) is found for this home address (Step S430). In this case, the home agent 110 proceeds to check whether the Force flag 200 is set or not (Step S450). Because the Force flag 200 is not set, the home agent 110 sends a binding error message with a reason code to indicate to the mobile router 130 that an existing legitimate entry relating to this home address and to the mobile network prefix already exist, and rejects the binding (Step S470). It is desirable that an identification information of the mobile router 120 (e.g. care-of address of the mobile router 120) currently performing the function as dynamic home agent is notified in this binding error message.

In FIG. 5, the mobile router 130 receives the binding message and grasps that the binding has been rejected (Step S520) and proceeds to send a registered Query message including the next parameters such as those shown in FIG. 3 to the mobile router 120 (i.e. a dynamic home agent) (Step S540).

A network size 300 is a parameter to indicate the number of nodes (including the mobile router 130 itself), which is considered to be present in the mobile network of the mobile router 130. A preferred home address 310 is an optional parameter describing the home address, which the mobile router 130 is going to use. A preferred network prefix 320 is an optional parameter describing the mobile network prefix, which the mobile router 130 is going to use. A prefix length 330 is an optional parameter to describe the length of the mobile network prefix, which would be wanted to utilize by the mobile router 130.

The optional parameter may preferably be left out or may be set to zero, depending on the condition of implementation. For instance, when starting up, the mobile router 130 merely sets the parameter of necessary network size 300 without putting anything to the optional parameter at the time of starting. The parameter of the network size 300 may be set either by user's input or by prior user's setting or dynamically acquired information can be set based on an algorithm such as number of current nodes within the mobile network. Also, these parameters may optionally be gathered under a new mobility header, which is called the request mobility header.

The parameters shown in FIG. 2 are also included in the registration request message. These parameters may be collectively gathered again in the Query mobility header. The fields of the authentication token 210 and the identification token 220 may not necessarily be the same as those transmitted to the home agent 110. Instead, these may be values with only local significance in the mobile routers 120, 130 and 140, and the decision as to which method should be used varies according to the condition of implementation to the preference of the user. Here, assumption is made on a case where a registration request message is sent in form of binding update with a Query mobility header and a request mobility header.

When a binding update (registered binding update request) with a Query mobility header and a request mobility header is received, the mobile router 120 proceeds to verify identification information of the mobile router 130. If it is successfully verified, the mobile router 120 proceeds to inspect the content of the request mobility header. In case only the parameters of the network size 300 are set, the mobile router 120 proceeds to allocate home address, suitable mobile network prefix and prefix length to the mobile router 130. This is carried out via a binding acknowledgment message, to which the request mobility header including the field with the allocated values is added.

The network size 300 may be set up so that it indicates maximum allowable number of nodes based on a predetermined mobile network prefix. If the mobility router 130 is not satisfied with a value supplied from the mobile router 120 or if the binding of a predetermined condition is not acceptable, the procedure to negotiate for another different set of parameters (Step S560) may be repeated. In this case, the mobile router 130 may try to send a request of a smaller network size 300 to the same preferred home address 310.

The above process may be set in advance by the user. For instance, the user may divide mobile network prefix into equal portions in advance so that it can be shared equally among a plurality of mobile routers, which belong to the user. Further, the user may statically configure which mobile router is to receive which address block. Because the setting is determined in advance in this method, it is advantageous in that the competition can be avoided, which may occur due to the restarting or to the change of mobile router. However, there are also disadvantages, e.g. the number of mobile network nodes to be accommodated by the each mobile router is limited by the user, or the amount of advance setting (pre-configuration) to be executed by the user is increased.

In another preferred embodiment, it is possible to leave a certain field so that dynamic negotiation can be made among the mobile routers. Also, in a fully dynamic embodiment, every field is dynamically filled by an algorithm or by user input (when necessary). This method is advantageous in that advance setting by the user can be reduced and that address resource can be more efficiently utilized and the mobile network can be set up in more flexible manner. According to this method, however, it would be necessary to exchange messages for a long time between the mobile routers. This may cause further delay and add the possibility of competition caused by the restarting or the change of the mobile routers.

When home address or mobile network prefix are allocated to the mobile routers, it is desirable to allocate them continuously (sequentially). For instance, it is supposed here that the mobile network prefix is “3000:0:0:0:1::/80”. If it is assumed that the mobile router 120 needs to have the network size “65000” for its mobile network, the mobile router 120 subscribes a network prefix of “3000:0:0:0:1:0:1::/112” to the mobile router 120 itself. If the mobile router 130 also requests mobile network prefix of “65000” home address and network size “65000”, similarly the mobile router 120 gives a sequence number “3000::1:0:2:1/112” as its home address and also gives a sequence number “3000:0:0:0:1:0:2::/112” as the mobile network prefix. In case the network size is the same in all of the mobile routers belonging to the user, it is possible to use both types of sequence numbers: i.e. in ascending order and descending order. When allocation is executed sequentially, the risk of address competition can be reduced even when dynamic home agent loses the connectivity.

At this moment, the mobile router 120 fulfills the function as a home agent to the mobile router 130. Therefore, a message from the mobile router or from the mobile network 135 is tunneled to the home agent 110 after passing through the mobile router 120. Then, it is decapsulated at the home agent 110 and is transmitted along the route. Or, reversely, the same applies to an arriving message addressed to the mobile router 130 or the mobile network 135. In the mobile router 130 or the mobile network 135, route optimization processing or related processing and data route, etc. are still operated normally. Also, a mobile router 140 and a mobile network 145 are changed to “on line”. It is supposed here that the mobile router 120 performs the processing to acquire home address and mobile network prefix.

When the mobile router 120 loses connectivity, two different situations may occur. The first situation is a case where the loss of connectivity can be anticipated. In this case, the mobile router 120 designates a mobile router as successor, and the duties of dynamic home agent may be inherited. For instance, the mobile router 120 can update the current binding cache entry to the successor mobile router and may notify that the functions of dynamic home agent have been shifted to the home agent 110. In so doing, dynamic home agent can smoothly and seamlessly perform handover.

On the other hand, the second situation is a case where the loss of the connectivity cannot be anticipated. In this case, when other mobile routers 130 and 140 recognize that the connectivity with the mobile router 120 has been lost because the packet of anticipated data plane is lacking or the acknowledgement to be sent to the binding update message is lacking (Step S570), it attempts to contact (to re-establish the connectivity) to the mobile router 120 as many times as adequate (Step S580). For instance, the mobile router 130 attempts to have a contact for once, and the mobile router 140 tries to have contact three times. When the contact with the dynamic home agent (mobile router 120) has failed, the mobile router 130 proceeds to send a Query message with the Force flag set to “true” together with the binding update to the home agent 110 (Step S510).

In another embodiment, it may be so designed that each mobile router has weight or priority set in advance to define the number of the attempts to have contact with the dynamic home agent. For instance, the mobile router with higher priority may have lower number of attempts to contact. Also, for the mobile router, to which higher weight is set, the time for re-attempt is set to a shorter time. In any of the embodiments, it is important to avoid the competition among the Query messages sent to the home agent 110 at the same time. Specifically, when the connectivity of the mobility router, which has been fulfilling the functions as a dynamic home agent, has been lost, it is desirable that a mobile router, inheriting the dynamic home agent functions, is set in advance by the priority, for instance.

After verifying the identifier of the mobile router 130, the home agent 110 discovers the existing entry relating to the mobile router 120 (Step S430). However, the home agent 110 confirms that the Force flag 200 is set to the Query message of the mobile router 130 and sends a binding refresh request to the mobile router 120, which has home address and mobile network prefix and is currently registered. In so doing, it is confirmed whether the current entry is valid or not (Step S460).

In case response cannot be received after attempting two or more times, the home agent 110 accepts binding update from the mobile router 130 and proceeds to update the entry be using information from the mobile router 130 with regard to the home address and the mobile network prefix (Step S440). When many mobile routers send the same request continuously (i.e. transmission of binding update from the mobile router 130 for the purpose of inheriting the dynamic home agent functions), the delay of the response to the mobile router 130 is worsen in the process of checking by the home agent 110, and the network resources may be wasted. Such disadvantage can be reduced through the implementation of simple algorithm such as the setting of a period (shorter time) by regarding an arbitrary response received from the mobile router 120 as valid.

After receiving the binding acknowledgement to acknowledge successful updating of the binding entry at the home agent 110, the mobile router 130 can be set as a new dynamic home agent. The mobile router 130 continues to use the home address and the mobile network prefix already set up for the data-plane communication.

Similar to the case of the mobile router 130 as described above, when the attempt to have contact with the mobile router 120 has failed, the mobile router 140 proceeds to send a request message with the Force flag 200 set to “true” together with the binding update to the home agent 110 (Step S510). The home agent 110 verifies that the current entry to represent the mobile router 130 is valid (Step S460) (by further sending a binding refresh request or by other algorithm such as effective response lifetime), and a binding error message is sent to the mobile router 140 with a reason code to indicate that the current legitimate entry relating to the home address or to the mobile network prefix already exists, and the binding is rejected (Step S470).

In this case, the mobile router 140 sets up a value acquired from the mobile router 120 in each field of the preferred home address 310, the preferred network prefix 320 and the prefix length 330, and it sends a registered request message including the request mobility header thus set to the mobile router 130.

Also, when the connectivity is restored, the mobile router 120 restarts the processing similar to the processing when it has been first turned to “online” (Step S571, S510).

The dynamic home agent, which has inherited the role from the previous mobile router (the previous dynamic home agent) may distribute mobile network prefixes overlapped on each other. As a method to avoid this problem, there is a method to wait for longer than the maximum interval period (i.e. longer than the period, during which re-registration of the binding update is requested) of the binding update accepted by local group of this mobile router before the dynamic home agent allocates a new binding. By this method, a current mobile router, which has already acquired the mobile network prefix, can have a chance to perform re-registration to the new dynamic home agent.

Further, according to still another embodiment, there is a case where the user is engaged in a contract to use one continuous block of the mobile network prefixes with a plurality of home addresses. In particular, this embodiment is related to a future cellular network. In this case, all user terminals have home addresses, while the mobile network prefixes must be individually registered. In this case, it would suffice that the behavior as described above is slightly changed. Then, the mobile router 130 sends a registration request message to seek the mobile network prefix (Step S540), and in case the mobile network prefix is already registered in the mobile router 120, the home agent 110 sends a binding error message with a reason code to indicate that there is an existing legitimate entry with regard to this mobile network prefix to the mobile router 130 after verifying that the mobile network prefix is registered to both of the mobile routers 120 and 130, and the home agent 110 rejects the binding (Steps S470 and S550). In this case, the home address of the mobile router 120 may be included in the binding error message, which is sent to the mobile router 130. As a result, the mobile router 130 can identify the mobile router 120, which has the mobile network prefix, and can start to negotiate for the sharing of the mobile network prefix (Step S560).

Further, in another embodiment, when the dynamic home agent has failed with abnormal termination (non-graceful failure), the dynamic home agent may use a predictive method so that the functions can be received and given in more seamless way. For instance, in actual behavior, a binding cache entry in the dynamic home agent can be copied and stored at another location. As such another location, the home agent of the service provider or other remote node already known may be used.

In another example derived from the above, the dynamic home agent may share the binding without another mobile router in operation in order to minimize the interruption of the service, which may occur during the receiving and the delivery of the functions of the dynamic home agent.

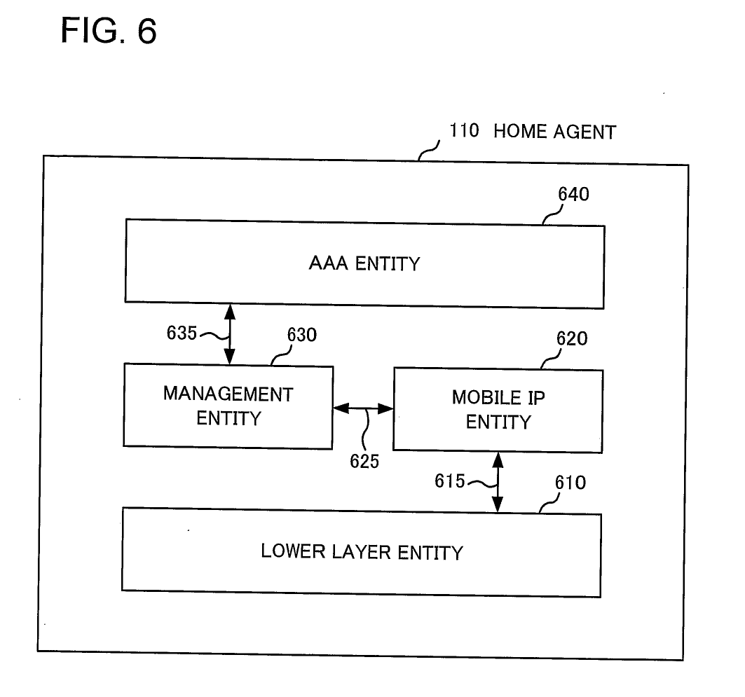

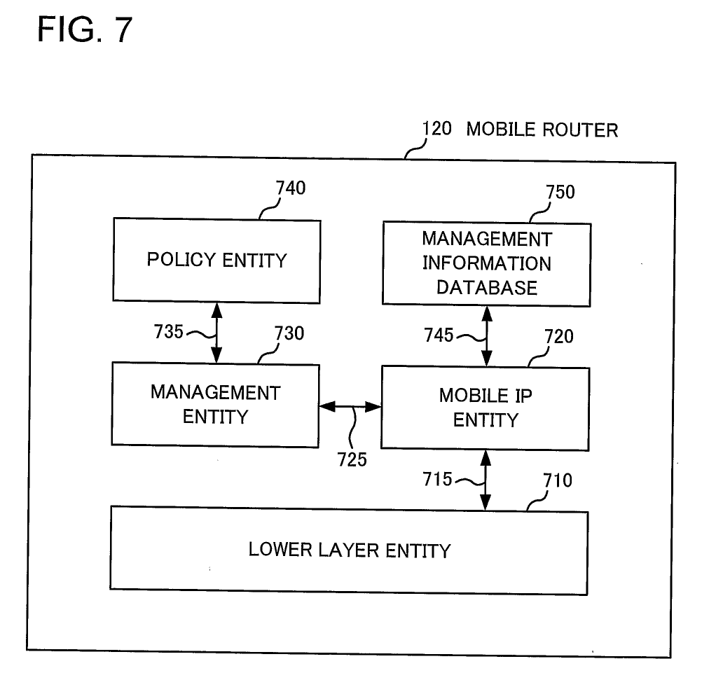

For the purpose of fulfilling the functions of the invention as described above, new functions must be introduced to the home agent 110 or to the mobile routers 120, 130 and 140. FIG. 6 shows an example of the functions provided on the home agent. An example of the functions provided on the mobile router is given in FIG. 7 in form of a functional block diagram.

In the home agent 110 shown in FIG. 6, a lower layer entity 610 is a source of a mobile IP message to be received by a node. This entity may be present in form of an access network interface and may be present with purely logical function or as an entity. An arriving message or a response to be delivered from mobile IP entity (mobile IP block or mobile IP protocol) 620 is notified via a path 615.

The mobile IP entity 620 makes inquiry to a management entity 630 via a path 625 with regard to the response, which is needed in the flow chart shown in detail in FIG. 4.

Also, the management entity 630 may utilize an AAA (Authentication, Authorization and Accounting) entity 640 via a path 635 depending on the circumstances and may acquire related necessary information. The AAA entity 640 and the management entity 630 may be arranged at any geographical location and may be commonly shared by a plurality of home agents.

In the mobile router 120 shown in FIG. 7, the lower entity 710 is a source of a mobile IP message to be received by a node. This entity may be present in form of an access network entity or as a purely logical function or entity. A Query message delivered or an arriving response or a request message from the mobile IP entity is notified via a path 715.

The management entity 730 starts the operation of a mobile IP entity 720 via a path 725 as shown in the flow chart of FIG. 5. Further, the management entity 730 makes inquiry to a policy entity 740 via a path 735 with regard to the priority or the weight to be used for the re-establishment of the connectivity or the behavior relating to the method using random values or to the needed network size.

Further, the mobile IP entity 720 may make inquiry to a management information database 750 via a path 745 periodically to update the dynamic home agent, for instance. The management information database 750 may be realized in a form to be added to MIB (Management Information Base). The policy entity 740 or the management entity 730 may be arranged at any geographical location and may be commonly shared by a plurality of home agents.

At an arbitrary location in the management entity 730, the policy entity 740, the management information database 750, etc., a list of information is stored, which include various type of information (i.e. the information corresponding to the identification token 220) to identify each of a plurality of mobile routers belonging to the user, to which the services according to the present invention are provided. By referring to this list, the home agent 110 of the service provider can verify a legitimate mobile router of a legitimate user, who is a subscriber of the services of the present invention. For instance, this is useful for preventing illegitimate use such as allocation of the mobile network prefix to a mobile router not registered.

The present invention can be applied to the scenario of wider range. For instance, the scenarios, to which the present invention can be applied, include: a case where a communication provider of cellular phone provides a family plan to a user of average level and to the family, or a case where service provider of wireless broadband offers a plan suitable for the use as a packet to a user, who does not frequently need a condition that one or more personal area networks are in on-line state.

Major advantages of the present invention are that a simple method to commonly share home address and mobile network prefix among the mobile routers can be realized. However, with regard to the inefficiency of additional routing (redundant path or occurrence of delay), which may take place when it is relayed via a path through the dynamic home agent, it is desirable that it can be solved by other arbitrary mechanism.

In the above-mentioned embodiments of the present invention, the user can have home address and mobile network prefix to be shared among mobile routers. In another embodiment of the present invention, the user subscribes for a similar resource sharing service with his mobile devices. In the following descriptions, such mobile devices are assumed to be enhanced mobile nodes with little or no router functionality, but they may be mobile routers with router functionality. The term “mobile node” used in this embodiment of the present invention represents both a mobile router and a mobile host according to the general usage of this technology.

In this embodiment of the present invention, the service (resource sharing service) that the user has subscribed to provides a single permanent IP address through which the user may be contacted via any of his mobile devices. Utilizing a similar mechanism to the above-described embodiment of the present invention, the user registers his mobile nodes which would be used for the IP address sharing service at the operator. The operator provides information such as some form of security token that would be tied to the individual mobile device. An example of such a token can be a SIM (Subscriber Identity Module) card that must be installed in each of the mobile nodes partaking in the service.

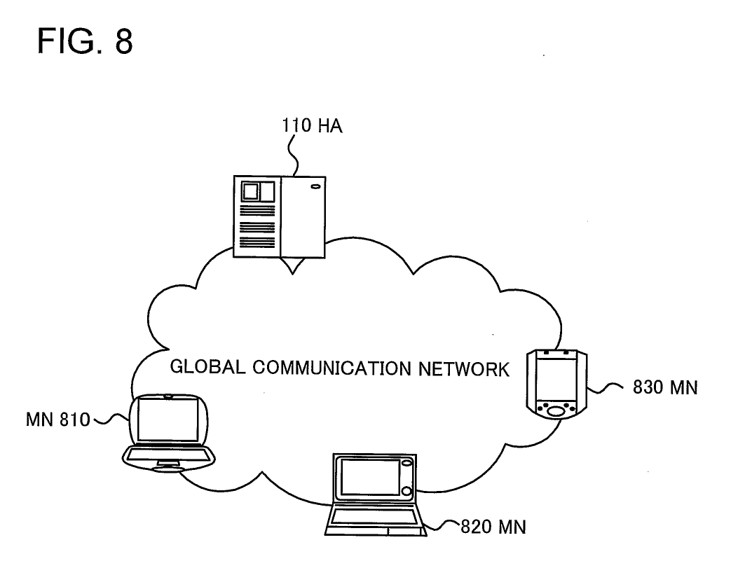

In another embodiment of the present invention, the usage of the Query message and the behavior of the home agent are virtually unchanged from those of the above-mentioned embodiments (Query message illustrated in FIG. 2 and flowchart of the behavior illustrated in FIG. 4). The key difference is that there are mobile nodes (mobile nodes 810, 820 and 830) as shown in FIG. 8 and these mobile nodes neither request nor need mobile network prefixes in another embodiment of the present invention, while there are mobile routers (mobile routers 120,130 and 140) as shown in FIG. 1 in the above-mentioned embodiments. In another embodiment of the present invention, the user subscribes to a service that allows a single IP address to be shared among plural mobile nodes (for example, three mobile nodes 810, 820 and 830). Mobility management is also provided by a home agent 110 controlled by the operator.

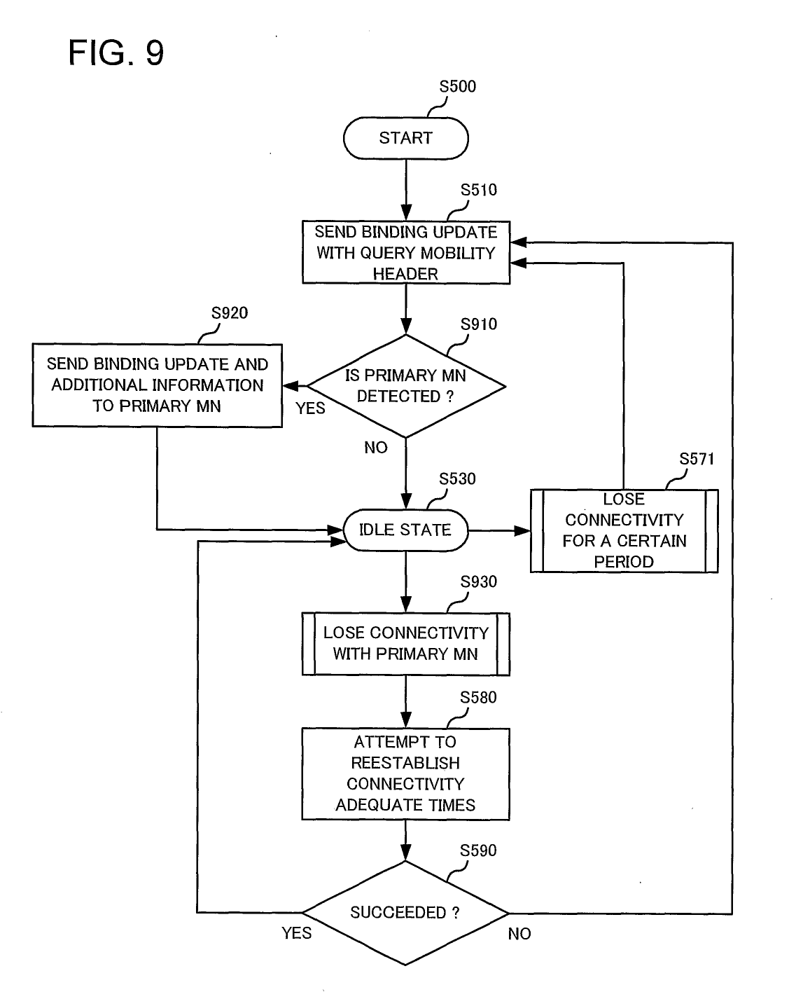

FIG. 9 illustrates a flowchart showing an example of the behavior of the mobile node in another embodiment of the present invention. Some parts of the behavior of the mobile node are identical to those of the mobile router previously described in FIG. 5 and the descriptions of those behaviors will be omitted here.

In FIG. 9, a specific implementation, mobile node 810 belonging to a subscriber of the address sharing service starts up and associates to the network (Step S500). The mobile node 810 proceeds to send a Binding Update message with the Query option (Query mobility header) attached to the home agent (Step S510). This Query option is used for the purpose that the mobile node 810 requests allowance to serve as a Primary MN (communication path setting node that sets communication paths to other mobile nodes 820 and 830). The home agent 110 grasps no record of an existing Primary MN for the mobile node 810, processes the binding update from the mobile node 810, and sends a binding acknowledgement message notifying the success of the binding update processing. When the mobile node 810 sending the binding update message, receives the binding acknowledgement message, it understands that no Primary MN has been found (Step S910) and moves to an idle state of behavior (Step S530).

When the user proceeds to start up a mobile node 820, the mobile node 820 will also send a binding update together with the Query option to the home agent 110 (Step S510). At this time, the home agent 110 would grasp the existence of an active Primary MN (mobile node 810), and then notify the existence of the Primary MN to the mobile node 820 (Step S910). This notification may preferably take the form of a binding error message with a pre-defined error code.

When the mobile node 820 grasp the existence of the Primary MN, it need proceed to send a binding update message together with any additional information to the mobile node 810 (which can be located by using the home address) (Step S920). The additional information is used by the mobile node 810 and the home agent 110 to make routing decisions for incoming packets. The additional information may take the form of capability or service information, policies, flow filters, etc. The mobile node 810 then updates the home agent 110 with the care-of address of mobile node 820 as a multiple care-of address entry.

The home agent 110 may accept the binding update from the mobile node 820 and also inform the mobile node 820 about the existence of a Primary MN. This could introduce the form of a new acknowledge code in the binding acknowledgement message or the form of a new dedicated option. The mobile node 820 proceeds to communicate with the Primary MN via the home address, and update the mobile node 810 by sending the additional information when necessary. The additional information is used by the Primary MN (mobile node 810) and the home agent 110 to make routing decisions for incoming packets. The additional information may take the form of capability or service information, policies, flow filters, etc.

The mobile node 820 may then inform the mobile node 810 that it is the recipient of any packets from a particular IP address or entity. In this mode of operation, the mobile node 810 need not send a binding update message on behalf of the mobile node 820 to the home agent 110. However, some methods must be utilized to synchronize the binding update messages between the mobile nodes. In case that the binding update messages are not synchronized, it is possible that legitimate binding cache entries for a mobile node may get overwritten by a binding update message from a different mobile node. In order to implement this, for example, the home agent 110 may use identification information (mobile node identifier) from each mobile node as a part of the relevant binding cache entry. Hence, the binding cache entry would consist of the single permanent home address followed by care-of address and mobile node identifier pairs.

During the course of the normal behavior, the mobile node 820 may detect that connectivity with the Primary MN (mobile node 810) has been lost. Detection of such an event may be due to a lack of acknowledgement to binding updates, an event originating from IEEE 802.21 Media Independent Handover services, or an update from the home agent 110. Upon occurrence of such an event, the mobile node 820 can proceed to attempt to re-establish connectivity as many times as adequate (or a random number of times) (Step S580). It should be noted that the random number of attempts in the connectivity re-establishment is simply a mechanism to avoid conflict when plural mobile nodes attempts to register themselves as the Primary MN at the same time. Accordingly, other mechanisms such as manual configuration may be utilized with no change to those of the above-mentioned embodiments. In case that the mobile node 820 can contact with the primary MN, it returns to the idle state. On the other hand, in case that connectivity has been lost, it takes to Step S510, and the mobile node 820 starts the process of registering itself as a new Primary MN at the home agent 110.

In another embodiment of the present invention, it is highly probable that the home agent 110 would be performing majority of the data forwarding. This is because the Primary MN would be a mobile node and thus would likely have neither data-forwarding nor routing capabilities. While the data forwarding performed by the mobile router that is functioning as a dynamic home agent in the above-mentioned embodiments, the Primary MN basically plays the role to determine the intended recipient of a data packet and to set policies, rules or filters at the home agent 110 to achieve this end in another embodiment of the present invention. In case that, for example, the mobile node 810 serves as the Primary MN and receives a packet whose intended recipient is the mobile node 820, the mobile node 810 may change packet forwarding setting (setting of routing) at the home agent so that all the similar packets are forwarded the mobile node 820. In this case, the mobile node 810 may proceed to set the filter rule so that all the packets from the same source are forwarded to the care-of address of the mobile node 820. Also, the mobile node 810 may proceed to set the filter rule so that all the packets with a specific data flow from a specific source are forwarded to the care-of address of the mobile node 820, by managing a combination sources and data flow information. The mobile node 810 may drop the packet which is destined to the mobile node 820, or return it to the home agent 110 for forwarding depending on implementation.

Furthermore, there is another case that the operator of home agent 110 tries to reduce its processing load and also conserve its bandwidth by not having to forward every data packet to the mobile nodes 810, 820 and 830. In this case, the home agent 110 may actively encourage correspondent nodes of the mobile nodes 810, 820 and 830 to utilize a direct path to the desired mobile nodes, not a path via the home agent 110. This case effects less delay of the data packet in traversing the Internet and also gives the advantage to the mobile node. This is achieved, but not limited to, by the mobile nodes utilizing the route optimization functionality of mobile IP whenever possible, or alternatively, the home agent 110 assisting in the setup of a route optimized path between the mobile node and its corresponding node.

In another embodiment, the reasons for a mobile node to assume the role of being the new Primary MN is not limited to the occasion when the current Primary MN is disconnected. For example, one reason may be such that the user may prefer to utilize a more powerful mobile node as the Primary MN. The other reasons for changing the Primary MN may include greater network throughput availability, power consumption, etc. For instance, taking the scenario of an office user, the Primary MN of the user may be the mobile phone when he is outside the office, but he may prefer to use his desktop computer when he is in the office or at home. In such a scenario, the Primary MN may be decided on the basis of manual configuration, policy or some form of negotiation among the mobile nodes.

In deciding the change of the Primary MN, in case that the home agent has decided a new Primary MN, the home agent would notify the end of the role to the previous Primary MN and also notify to start the role as the Primary MN to the new Primary MN. In case that a single or plurality of MNs have decided a new Primary MN, the decision is notified to the home agent, and the home agent is also requested to update its cache and routing table so that the packets to be sent to the previous Primary MN could forward to the new Primary MN. The above notification may be implemented as an option in an adequate message such as a binding update message, binding acknowledgement message or a binding error message, or may be sent and received in the form of the independent notification message.

In another preferred embodiment, the above-described mechanism of the present invention for resource sharing among mobile nodes is enhanced to provide access control capabilities. In this implementation, the user designates a specific mobile node to be the Primary MN. This would allow the Primary MN to control access to the other mobile nodes (Secondary mobile nodes). This would be useful, for example, in the case when a parent allows his children to use a cellular phone (Secondary MN) for convenience but wants to prevent strangers from chatting with them or exchanging messages. Furthermore, the above-described mechanism of the present invention for resource sharing among mobile nodes can be applied to the extension telephone system of the office. In this scenario, the Primary MN receives call from the outside wire because it is acting as the telephone node on behalf of the other telephones in the office. It is useful to have the extension number inputted, or transfer the call manually or automatically by using the Primary MN to receive the call from the outside wire. The user designates his terminal as the Primary MN and then sets policy and rules for only authorized correspondent nodes to communicate with the Secondary MN. Information on the receiver to receive incoming packets (call or message) may be acquired from the information regarding SIP (Session Initiation Protocol). When the Secondary MN receives a packet sent from an unauthorized source (correspondent node), the home agent 110 may send this packet to the Primary MN, and the Primary MN may decide whether the reception of the packet should be permitted or not, for instance.

The decision made by the Primary MN whether the reception of the packet should be permitted or not, may be notified to the home agent at every time of making decisions, or may be stored in the home agent as a list of communicatable nodes. Furthermore, packets may be selected by setting an authorized flow as a flow filter based on the decision. The notification messages of the above cases may be implemented as an option or flow setting information in a binding update message, or may be sent and received in the form of the independent notification message. Furthermore, it is natural that the similar mechanism of the Primary MN can be applied according to need of the applications in relation to the access control for transmission from the Secondary MN.

As another example of the application of the mechanism of the present invention for resource sharing among mobile nodes, it may be the case where only a single address is notified to the correspondent node. In this case, by the behavior of the present invention, the Primary MN can set suitable policies or filters at the home agent 110, and switch the communication from the correspondent node to the mobile node which is a target service accepter. Considering the case of a network of video cameras (mobile nodes) operated by the user, when the correspondent node contacts with the user via the permanent IP address and requests the images from the selected video camera, the Primary MN can forward the session to the requested node transparently.

Furthermore, the user which subscribes to the address sharing service can sublet the permanent IP address to other subscribers (i.e. the user acts as a broker). In this case, only the Primary MN would be authorized to send a binding update message to the home agent. This case would mandate some form of security and privacy to be placed between the home agent, Primary MN and Secondary MNs.

In another embodiment of the present invention, the primary MN functionality can be smoothly transferred to another mobile node by procedures similar to those of the above-mentioned embodiments (embodiments regarding transferring a dynamic home agent) when it is detected that the mobile node which serves as a Primary MN, has lost its connection (or, is about to lose its connection).

Here, the present invention has been disclosed and described by making an assumption on the most practical and preferable embodiment. It would be obvious to those skilled in the art that various modifications can be made without departing from technical scope and spirit of the present invention with regard to the details such as architecture including the management entities 630 and 730 and other components and parameters.

Each of the functional blocks used in the description of the embodiments of the present invention can be realized as LSI (Large Scale Integration), which is typically represented by an integrated circuit. These may be manufactured individually as one chip or may be manufactured as one chip including a part or all. Here, it is referred as LSI, while it may be called IC (Integrated Circuit), system LSI, super LSI or ultra LSI depending on the difference in the degree of integration.

The technique to produce the integrated circuit is not limited to the technique of LSI, and it may be realized as a special-purpose circuit or a general-purpose processor. After the manufacture of LSI, FPGA (Field Programmable Gate Array) or reconfigurable processor may be used, in which the connection and the setting of circuit calls inside LSI can be reconfigured.

Further, with the progress in the semiconductor technique or with the emergence of other technique derived from it, if a new technique of circuit integration to replace LSI may appear, the functional blocks may naturally be integrated by using such technique. For instance, the adaptation of biotechnology may be one of such possibilities.

### INDUSTRIAL APPLICABILITY

The present invention provides such effects, in a system where a plurality of mobile nodes are in operation, that network services under the management of the service provider can be adequately offered and also the effects that common sharing of resources among a plurality of mobile nodes can be realized. This technique can be applied in the communication technique in packet exchange type data communication network and can also be applied in the technical field relating to common sharing of network services and resources based on AAA.

1. A communication management apparatus being placed in a mobile node, the communication management apparatus being feasible to manage communication performed by other communication nodes, wherein the communication management apparatus comprises;
Query message sending means for sending a Query message including information to indicate that the mobile node is already registered and a binding update message for registration of location to a location management apparatus in charge of location management of said mobile node; and
communication management means for functioning as a primary node which manages the communication of a plurality of predetermined mobile nodes when said mobile node is confirmed as a registered device by said location management apparatus, said binding update message is accepted, a home address is allocated from the location management apparatus and said mobile node is permitted given to serve as the primary node which manages communication of the mobile node.

2. The communication management apparatus according to claim 1, wherein the mobile node where the communication management apparatus resides is a mobile router, and said mobile node functions as a dynamic home agent to a plurality of predetermined mobile nodes when the mobile network prefix is allocated with the home address from the location management apparatus and said mobile node serve as the primary node.

3. The communication management apparatus according to claim 2, wherein said Query message requests a permission to fulfill functions as the dynamic home agent.

4. The communication management apparatus according to claim 2, wherein said communication management apparatus comprises registration message sending means for sending a registration request message for requesting a home address and a mobile network prefix and a binding update message for location registration to a mobile node currently fulfilling functions as a dynamic home agent among the plurality of predetermined mobile nodes in case said binding update message has not been accepted.

5. The communication management apparatus according to claim 4, wherein said communication management apparatus comprises negotiating means to have negotiation relating to said home address and said mobile network prefix to and from the mobile router currently fulfilling functions as a dynamic home agent in case said binding update message is accepted and the home address and the mobile network prefix are allocated from the mobile router currently fulfilling functions as said dynamic home agent or in case said binding update message is not accepted.

6. The communication management apparatus according to claim 2, wherein said communication management apparatus comprises:
disruption predicting means for predicting disruption of connectivity at said mobile router in advance; and
dynamic home agent function shifting means for proceeding to shift the functions of said dynamic home agent to a mobile router among plurality of predetermined mobile nodes in case the disruption of said connectivity is predicted by said disruption predicting means.

7. The communication management apparatus according to claim 4, wherein said communication management apparatus comprises:
disruption detecting and confirming means for detecting and confirming disruption of connectivity at the mobile router currently fulfilling functions as said dynamic home agent; and
re-Query message sending means for sending a Query message added with a flag to urge re-confirmation of binding information and a binding update message for location registration, and for requesting permission to fulfill functions as the dynamic home agent including information to indicate that it is a registered device to a home agent for performing location management of said mobile router in case disruption of connectivity at the mobile router currently fulfilling functions as said dynamic home agent has been confirmed.

8. The communication management apparatus according to claim 1, wherein the mobile node in which the communication management apparatus resides is a mobile host, and said mobile node functions as a communication path setting node which sets a communication path of each of a plurality of predetermined mobile nodes when the mobile node serves as the primary node.

9. The communication management apparatus according to claim 8, wherein said Query message is to request permission to fulfill functions as said communication path setting node.

10. The communication management apparatus according to claim 8, wherein the communication management apparatus comprises:
register message sending means for sending a message including necessary information to set a communication path for the mobile node and a binding update message for registering location to a mobile node functioning as a communication path setting node among the plurality of the predetermined mobile nodes in case said binding update message has not been accepted.

11. The communication management apparatus according to claim 8, wherein the communication management apparatus comprises:
disruption predicting means for predicting disruption at the mobile node in advance; and
communication path setting node function shifting means for proceeding to shift the functions of said communication path setting node to a mobile node among the plurality of predetermined mobile nodes in case that the disruption of said connectivity is predicted by said disruption predicting means.

12. The communication management apparatus according to claim 10, wherein the communication management apparatus comprises:
disruption detecting and confirming means for detecting and confirming that disruption of connectivity at a mobile node currently fulfilling functions as the communication path setting node; and
re-Query message sending means for sending a Query message added with a flag to urge re-confirmation of binding information and a binding update message for location registration, and for requesting permission to fulfill functions as the communication path setting node including information to indicate that it is a registered device to the location management apparatus for performing location management of a mobile node currently fulfilling functions as said communication path setting node in case disruption of connectivity at the mobile node currently fulfilling functions as said communication path setting node has been confirmed.

13. A location management apparatus for managing location of a mobile node wherein said location management apparatus comprises:
registration list maintaining means for maintaining a registration list by making a set of a plurality of mobile nodes;
binding cache for storing binding information to execute location management of said plurality of mobile nodes;
message receiving means for receiving a Query message including information to indicate that it is a registered device in said registration list and a binding update message for location registration from the mobile node;
verifying means for verifying legitimacy of said mobile node according to said registration list; and
primary node function permitting means for giving permission to function as a primary node which manages communication of other mobile nodes to a mobile node which is a source of said Query message when legitimacy of said mobile node has been confirmed by said verifying means.

14. The location management apparatus according to claim 13, wherein a source of said Query message is a mobile router, and said Query message is to request permission to fulfill functions as said dynamic home agent far another mobile node.

15. The location management apparatus according to claim 14, wherein said location management apparatus comprises:
dynamic home agent confirming means for judging whether it is adequate or not that said mobile node successfully verifying said legitimacy fulfills functions as a dynamic home agent by referring to said registration list and said binding information; and
said address/prefix allocating means for allocating a home address and a mobile network prefix to the mobile node which is the source of said Query message, and storing the allocated home address and mobile network prefix along with current location information of the mobile node as the binding information in case the legitimacy of said mobile router has been confirmed by said verifying means and in case said dynamic home agent confirming means judges it as adequate.

16. The location management apparatus according to claim 13, wherein a source of said Query message is a mobile node, and said Query message is to request permission to fulfill functions as a communication path setting node which sets a communication path of another mobile node.

17. The location management apparatus according to claim 16, wherein said location management apparatus comprises:
communication path setting node confirming means for judging whether it is adequate or not that said mobile node successfully verifying said legitimacy fulfills functions as a communication path setting node by referring to said registration list and said binding information; and
said primary node function permitting means for giving permission to function as a primary node which manages another mobile node to the mobile node which is the source of said Query message in case the legitimacy of said mobile node has been confirmed by said verifying means and in case said communication path setting node confirming means judges it as adequate.
